(19) United States
(12) Patent Application Publication
(10) Pub. No.: US 2013/0314422 A1
(43) Pub. Date: Nov. 28, 2013

(54) DISPLAY DEVICE AND CONTROL METHOD THEREOF

(71) Applicant: INNOLUX CORPORATION, Miao-Li County (TW)

(72) Inventors: Yung-Yu TSAI, Miao-Li County (TW); Chien-Chou CHENG, Miao-Li County (TW)

(73) Assignee: InnoLux Corporation, Miao-Li County (TW)

(21) Appl. No.: 13/887,544

(22) Filed: May 6, 2013

(30) Foreign Application Priority Data
May 24, 2012 (TW) 101118467

(51) Int. Cl. G09G 5/391

(52) U.S. Cl. CPC G09G 5/391
USPC 345/428

(57) ABSTRACT

A display device including a display panel and a timing controller is disclosed. The display panel displays an image according to an output image. The timing controller includes a receiving unit, a first transformation unit, a second transformation unit and a processing unit. The receiving unit generates a processing image and a read-out image according to a first input image and a second input image. The first transformation unit transforms the processing image to generate a first transformed image. The second transformation unit transforms the read-out image to generate a second transformed image. The processing unit processes the first and the second transformed images to generate the output image. A resolution of the processing image and a resolution of the read-out image are less than a resolution of the display panel.

### CROSS REFERENCE TO RELATED APPLICATIONS

This application claims priority of Taiwan Patent Application No. 101118467, filed on May 24, 2012, the entirety of which is incorporated by reference herein.

### BACKGROUND

1. Field of the Invention

The disclosure relates to a display device, and more particularly to a display device, which is capable of reducing a bandwidth of a memory.

2. Description of the Related Art

Because cathode ray tubes (CRTs) are inexpensive and provide high definition, they are utilized extensively in televisions and computers. With technological development, new flat-panel displays are continually being developed. When a larger display panel is required, the weight of the flat-panel display does not substantially change when compared to CRT displays.

With an increase in the resolution of the display panel, an amount of image data required by the display panel is increased. To access the image data, a conventional method increases the number and bandwidth of memory. Thus, the cost of the flat-panel display is increased.

### SUMMARY

In accordance with an embodiment, a display device comprises a display panel and a timing controller. The display panel displays an image according to an output image. The timing controller comprises a receiving unit, a first transformation unit, a second transformation unit and a processing unit. The receiving unit generates a processing image and a read-out image according to a first input image and a second input image. The first transformation unit transforms the processing image to generate a first transformed image. The second transformation unit transforms the read-out image to generate a second transformed image. The processing unit processes the first and the second transformed images to generate the output image. A resolution of the processing image and a resolution of the read-out image are less than a resolution of the display panel.

In accordance with a further embodiment, a method comprises: receiving a first input image and a second input image; storing the first and the second input images and generating a processing image and a read-out image; transforming the processing image to generate a first transformed image; transforming the read-out image to generate a second transformed image; processing the first and the second transformed images to generate an output image; and providing the output image to a display device to display an image. A resolution of the processing image and a resolution of the read-out image are less than a resolution of the display device.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a display device;

FIGS. 2-5 are schematic diagrams of other exemplary embodiments of the timing controller; and

FIGS. 6-7 are schematic diagrams of other exemplary embodiments of a control method.

### DETAILED DESCRIPTION

The following description is exemplary embodiments of carrying out the invention. This description is made for the purpose of illustrating the general principles of the invention and should not be taken in a limiting sense. The scope of the invention is best determined by reference to the appended claims.

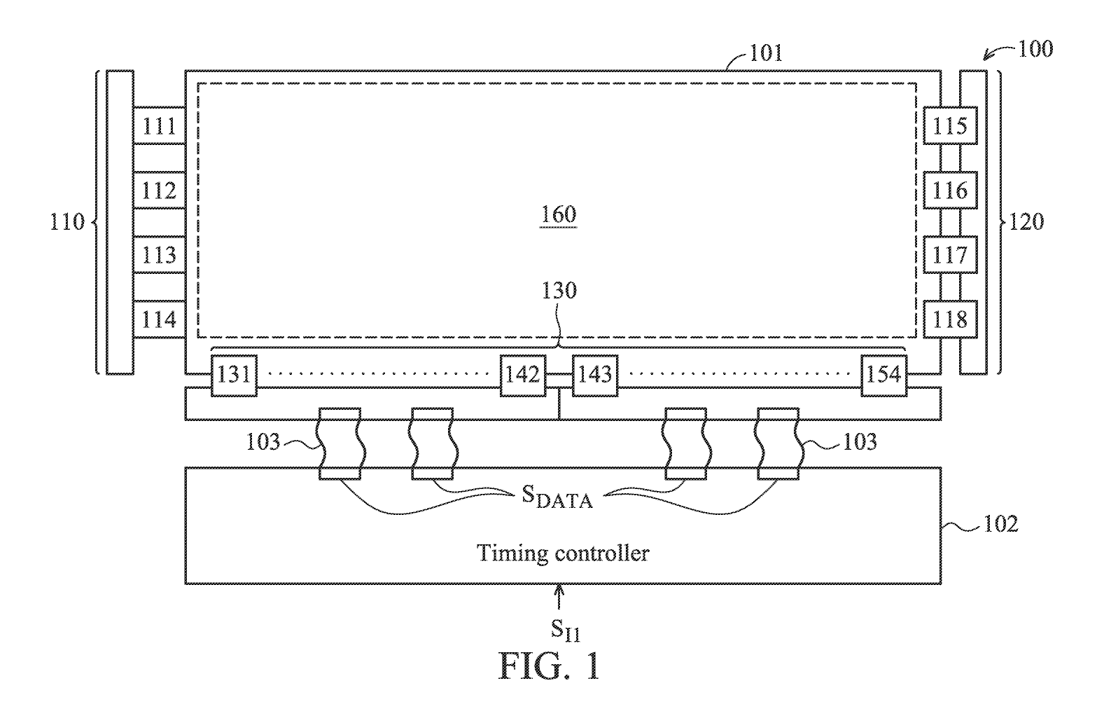

FIG. 1 is a schematic diagram of an exemplary embodiment of a display device. The display device 100 comprises a display panel 101 and a timing controller (TCON) 102. In this embodiment, the timing controller 102 controls the display panel 101 via a flexible printed circuit (FPC) 103 such that an image is displayed by the display panel 101. The invention does not limit the kind of the display panel 101. In one embodiment, the display panel 101 is a self-luminescent panel or a reflective panel. In another embodiment, the resolution of the display panel 101 is 3840×2160.

The invention does not limit the kind of the display device 100. In one embodiment, the display device 100 is a personal digital assistant (PDA), a cellular phone, a digital camera (DSC), a television, a global positioning system (GPS), a car display, an avionics display, a digital photo frame, a notebook computer (NB), or a personal computer (PC).

In this embodiment, the display panel 101 comprises scan groups 110 and 120, a data group 130 and a display region 160, but the disclosure is not limited thereto. In other embodiments, any circuit structure can be applied in the display panel 101, as long as the circuit structure is capable of displaying an image in the display region 160.

As shown in FIG. 1, the scan group 110 is placed on the left hand side of the display region 160 and comprises gate drivers 111-114. The scan group 120 is placed on the right hand side of the display region 160 and comprises gate drivers 115-118. The gate drivers 111-118 provide a plurality of scan signals to pixels in the display region 160. The invention does not limit the number and the position of the scan groups. In one embodiment, the display panel 101 only comprises a single scan group and is placed on any side of the display region 160. In another embodiment, the number of the gate drivers is proportional to the number of the pixels in the display region 160.

In this embodiment, the data group 130 comprises source drivers 131-154 to provide a plurality of data signals to the pixels in the display region 160. The invention does not limit the number of the source drivers. In one embodiment, the number of the source drivers is proportional to the number of the pixels in the display region 160.

The timing controller 102 generates a serial output image S_{DATA} to the display panel 101 according to a serial input image S_{I} such that the display panel 101 displays a serial image according to the serial output image S_{DATA}. The invention does not limit the format of the input image S_{I}. In one embodiment, the input image S_{I} is a low voltage differential signaling (LVDS) format.

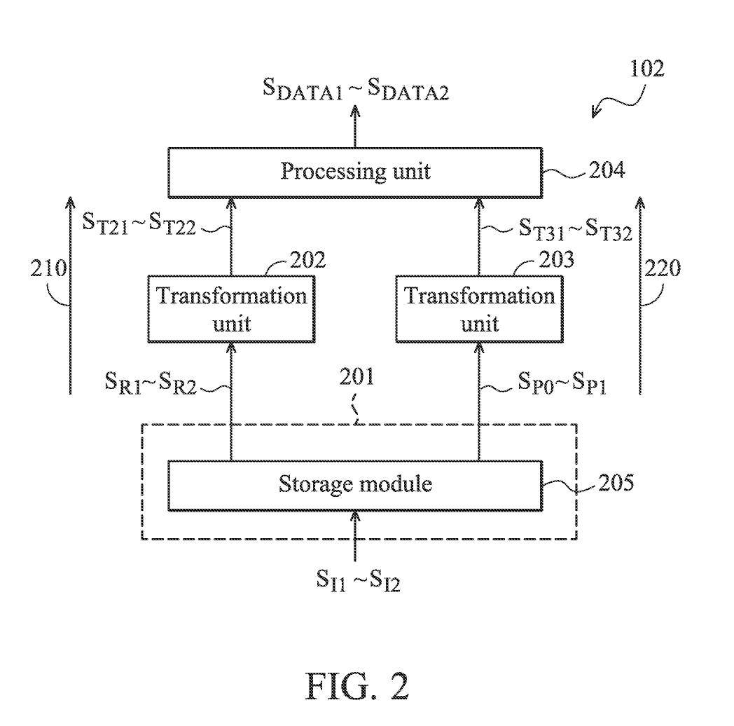

FIG. 2 is a schematic diagram of an exemplary embodiment of the timing controller. The timing controller 102 sequentially receives input images S_{I1} and S_{I2} and sequentially generates output images S_{DATA1}˜S_{DATA2}. In this embodiment, the timing controller 102 comprises a receiving unit 201, transformation units 202, 203 and a processing unit 204.

The receiving unit 201 generates read-out images S_{R1}˜S_{R2} according to the input images S_{I1}˜S_{I2}. In this embodiment, the receiving unit 201 comprises a storage module 205 to store the input images S_{I1}˜S_{I2} and serves the input images S_{I1}˜S_{I2} as the read-out images S_{R1}˜S_{R2}. In one embodiment, the resolutions of the read-out images S_{R1}˜S_{R2} are equal to the resolutions of the input images S_{I1}˜S_{I2}, such as 1920×1080.

In this embodiment, the receiving unit 201 further provides processing images S_{P0}˜S_{P1}. The invention does not limit the relationship between the processing images S_{P0}˜S_{P1} and the read-out images S_{R1}˜S_{R2}. In one embodiment, the resolutions of the processing images S_{P0}˜S_{P1} are equal to the resolutions of the read-out images S_{R1}˜S_{R2}. In another embodiment, the processing image S_{P0} is a pre-determined image, and the processing image Sp is the same as the read-out image S_{R1}. In other embodiments, the resolutions of the processing images S_{P0}˜S_{P1} and read-out images S_{R1}˜S_{R2} are less than the resolution of the display panel 101. The resolution of the display panel 101 may be 3840×2160.

The transformation unit 202 transforms the read-out images S_{R1}˜S_{R2} to generate transformed images S_{T21}˜S_{T22}. In this embodiment, after transformation, the resolutions of the transformed images S_{T21}˜S_{T22} are larger than the resolutions of the read-out images S_{R1}˜S_{R2}. In one embodiment, the resolution of one of the transformed images S_{T21}˜S_{T22} is equal to the resolution of the display panel 101.

The transformation unit 203 transforms the processing images S_{P0}˜S_{P1} to generate transformed images S_{T31}˜S_{T32}. Similarly, after transformation, the resolutions of the transformed images S_{T31}˜S_{T32} are larger than the resolutions of the processing images S_{P0}˜S_{P1}. In this embodiment, the resolution of one of the transformed images S_{T31}˜S_{T32} is equal to the resolution of the display panel 101.

The invention does not limit the circuit structures of the transformation units 202 and 203. Taking the transformation unit 202 as an example, any circuit structure can serve as the transformation unit 202, as long as the circuit structure is capable of adjusting the resolutions of the read-out images S_{R1} and S_{R2}. In one embodiment, the transformation unit 202 is a Scaler or a super resolution processor.

The processing unit 204 processes the outputs of the transformation units 202 and 203 to generate the output image S_{DATA1} and S_{DATA2}. The display panel 101 sequentially displays two images according to the output images S_{DATA1} and S_{DATA2}. The invention does not limit how the processing unit 204 processes the outputs of the transformation units 202 and 203. In one embodiment, the processing unit 204 processes the outputs of the transformation units 202 and 203 according to an over-driving (OD) process.

In this embodiment, the transformation unit 202 provides a first path 210 to transmit present image information and the transformation unit 203 provides a second path 220 to transmit previous image information for an OD process. The processing unit 204 executes the OD process for the image information transmitted by the paths 210 and 220.

During a first period, the storage module 205 stores the input signal S_{I1} and provides the read-out image S_{R1} according to the stored input signal S_{R1}. In this embodiment, the input signal S_{R1} is the same as the read-out image S_{R1}. Since the input signal S_{I1} is a first image, the storage module 205 provides a pre-determined image (e.g. S_{P0}) to the transformation unit 203. In this embodiment, the processing image S_{P0} is served as a previous image information.

The transformation units 202 and 203 transform the read-out image S_{R1} and the processing image S_{P0} to generate transformed images S_{T21} and S_{T31}, respectively. The processing unit 204 processes a present image (i.e. the transformed image S_{T21}) and a previous image (i.e. the transformed image S_{T31}) to generate the output image S_{DATA1} according to an OD process.

During a second period, the storage module 205 stores another input image S_{I2} and provides the read-out image S_{R2} according to the stored input image S_{I2}. In this embodiment, the read-out image S_{R2} is the same as the input image S_{I2}. Since the input image S_{I2} is a second image, the storage module 205 serves the previous image (i.e. the input image S_{I1}) as the processing image S_{P1}.

The transformation units 202 and 203 transform the read-out image S_{R2} and the processing image S_{P1} to generate transformed images S_{T22} and S_{T32}, respectively. The processing unit 204 processes the transformed images S_{T22} and S_{T32} to generate the output image S_{DATA2} according to an OD process.

In this embodiment, since the resolution of each image stored in the storage module 205 is less than the resolution of the display panel 101, the bandwidth of the storage module 205 is reduced. Taking a display panel as an example, assume the resolution of the display panel is 4 k2 k (i.e. 3840×2160). When the resolutions of the input images S_{I1} and S_{I2} are 3840×2160, the bandwidth and amount of the storage module 205 are required to be increased to store large image information. However, in this embodiment, the resolutions of the input images S_{I1} and S_{I2} are less than the resolution of the display panel. Thus, the bandwidth and amount of the storage module 205 are not required to be increased. In other embodiments, with an increase in the resolution of the display panel, the resolution of the display panel may be higher than 4 k2 k. In this case, the bandwidth and amount of the storage module 205 are not increased.

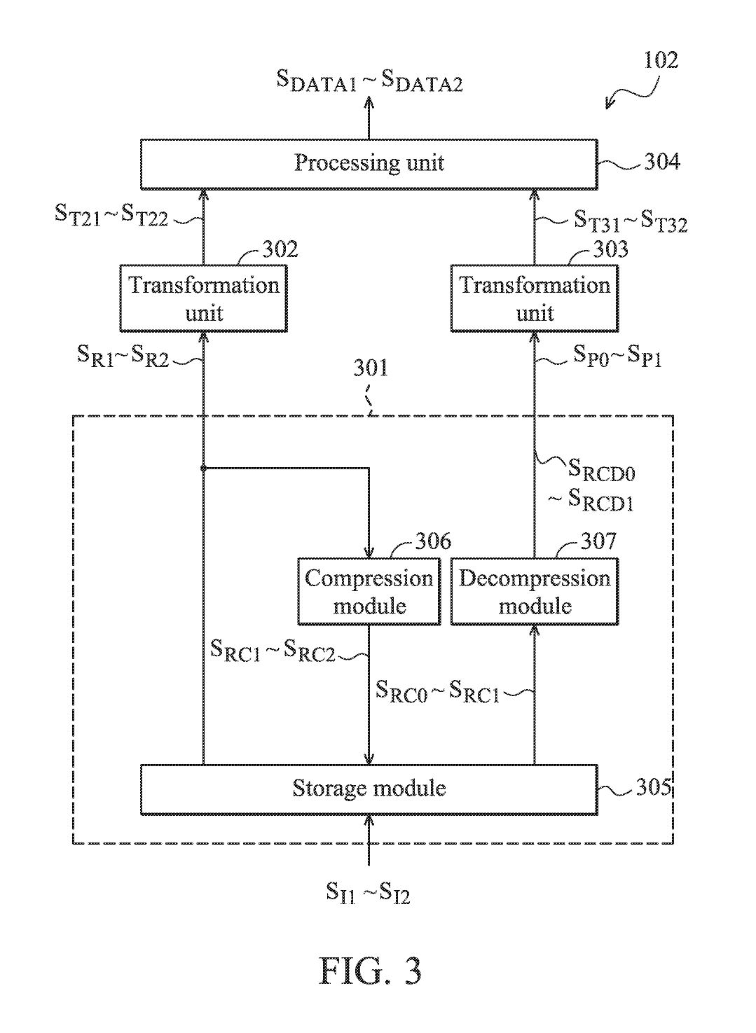

FIG. 3 is a schematic diagram of another exemplary embodiment of the timing controller. FIG. 3 is similar to FIG. 2 with the exception that the receiving unit 301 comprises a storage module 305, a compression module 306 and a decompression module 307. Since the operations of the transformation units 302, 303 and the processing unit 304 are the same as the operations of the transformation units 202, 203 and the processing unit 204, the descriptions of the transformation units 302, 303 and the processing unit 304 are omitted for brevity.

In this embodiment, when the transformation unit 302 transforms the read-out image S_{R1} or S_{R2}, the compression module 306 compresses the read-out image S_{R1} or S_{R2} to generate a compressed image S_{RC1} or S_{RC2}. The decompression module 307 decompresses the compressed image S_{RC0} or S_{RC1} stored in the storage module 305 and serves the decompressed result (e.g. the decompressed image S_{RCD0} or S_{RCD1}) as the processing image S_{P0} or S_{P1}.

The compressed image S_{RC1} or S_{RC2} generated by the compression module 306 is stored in the storage module 305 to replace the un-compressed image (e.g. S_{I1} or S_{I2}). Thus, the bandwidth of the storage module 305 can be reduced.

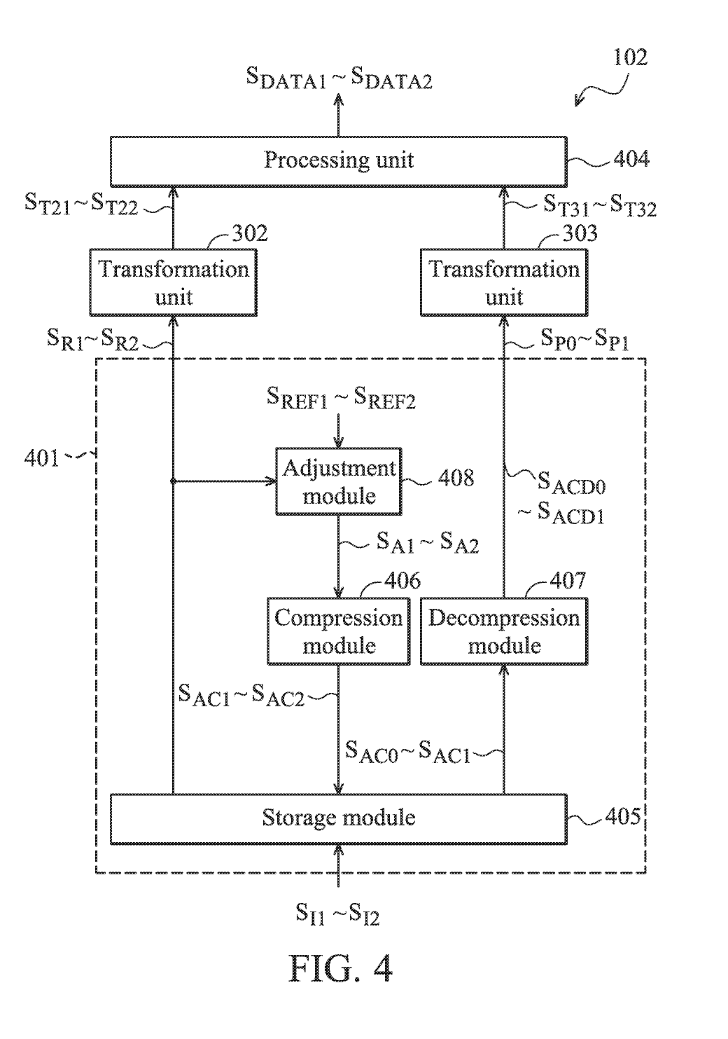

FIG. 4 is a schematic diagram of another exemplary embodiment of the timing controller. FIG. 4 is similar to FIG. 3 except for the addition of an adjustment module 408. Since the operations of the transformation units 402, 403 and the processing unit 404 are the same as the operations of the transformation units 302, 303 and the processing unit 304, the descriptions of the transformation units 402, 403 and the processing unit 404 are omitted for brevity.

In this embodiment, when the transformation unit 402 processes the read-out image S_{R1} or S_{R2}, the adjustment module 408 adjusts the read-out image S_{R1} or S_{R2} to generate an adjusted image S_{A1} or S_{A2} according to the reference condition S_{REF1} or S_{REF2}. The compression module 406 compresses the adjusted image S_{A1} or S_{A2} and stores the compressed result (e.g. S_{AC1} or S_{AC2}) in the storage module 405.

The invention does not limit the source of the reference condition S_{REF1} or S_{REF2}. In one embodiment, the reference conditions S_{REF1} and S_{REF2} are pre-determined. In another embodiment, the reference conditions S_{REF1} and S_{REF2} are previous images, such as the processing image S_{P0} and S_{P1}.

The invention does not limit how the adjustment module 408 adjusts the read-out images S_{R1}˜S_{R2}. In one embodiment, the adjustment module 408 executes an OD process. Taking the read-out images S_{R2} as an example, the adjustment module 408 utilizes the OD process to process the reference condition S_{REF2} and the read-out images S_{R2} to generate an adjusted image S_{A2}, wherein the reference condition S_{REF2} is the processing image S_{P1}.

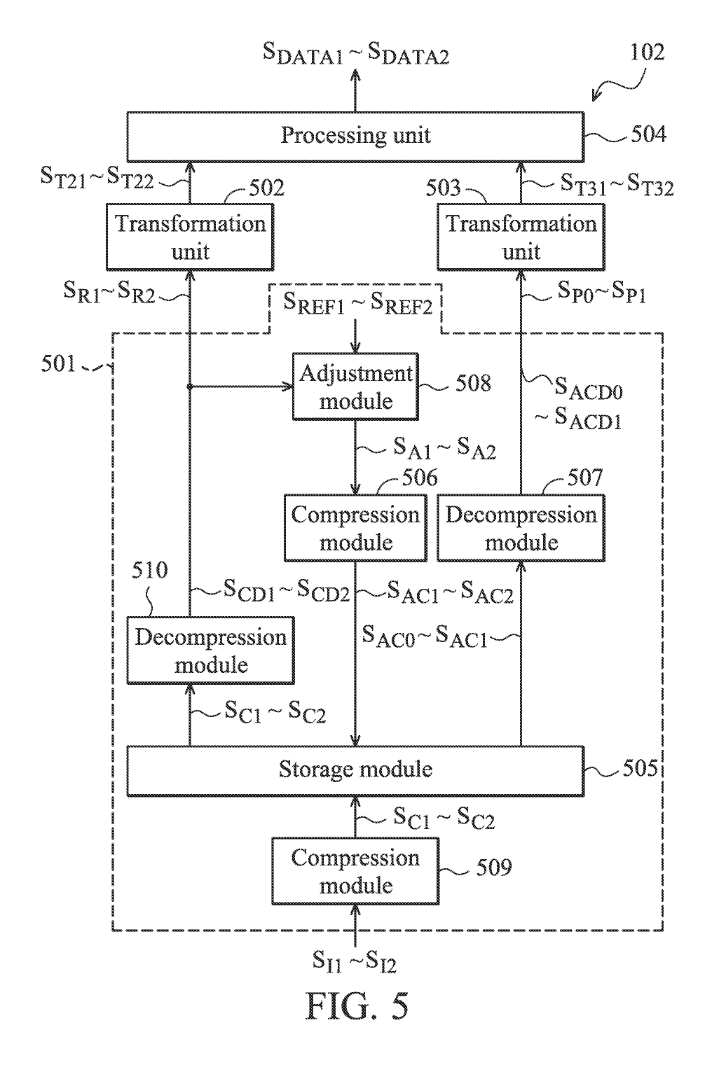

FIG. 5 is a schematic diagram of another exemplary embodiment of the timing controller. FIG. 5 is similar to FIG. 4 except for the additions of a compression module 509 and a decompression module 510. Since the operations of the transformation units 502, 503 and the processing unit 504 are the same as the operations of the transformation units 402, 403 and the processing unit 404, the descriptions of the transformation units 502, 503 and the processing unit 504 are omitted for brevity.

The compression module 509 compresses the input images S_{I1} and S_{I2} to generate compressed images S_{C1} and S_{C2}. The compressed images S_{C1} and S_{C2} are stored in the storage module 505. The decompression module 510 decompresses the compressed images S_{C1} and S_{C2} stored in the storage module 505 to generate decompressed images S_{CD1} and S_{CD2}. In this embodiment, the decompressed images S_{CD1} and S_{CD2} are served as the read-out images S_{R1} and S_{R2}.

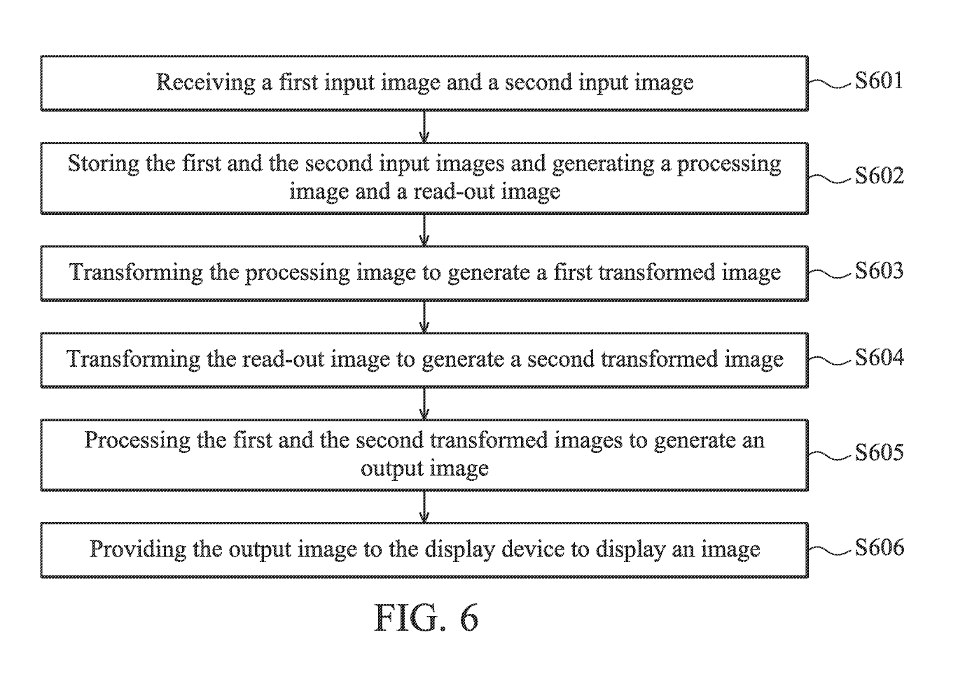

FIG. 6 is a schematic diagram of an exemplary embodiment of a control method. The control method is applied in a display device to display an image. First, a first input image and a second input image are received (step S601). The invention does not limit the formats of the first and the second input images. In one embodiment, the formats of the first and the second input images are LVDS formats. In another embodiment, the resolutions of the first and the second input images are 1920×1080.

The first and the second input images are stored and a processing image and a read-out image are generated (step S602). In one embodiment, the first and the second input images are stored in a DRAM. Additionally, the invention does not limit the generations of the processing image and the read-out image. In one embodiment, the processing image and the read-out image relate to the first and the second input images.

For example, during a first period, the first input image is stored and served as a read-out image. At this time, no a previous image occurred before the first input image such that a pre-determined image is beforehand stored and served as a processing image.

During a second period, the second input image is stored and served as another read-out image. At this time, since the first input image is a previous image occurring before the second input image, the first input image is served as a processing image. In this embodiment, the processing image is previous information and the read-out image is the present information.

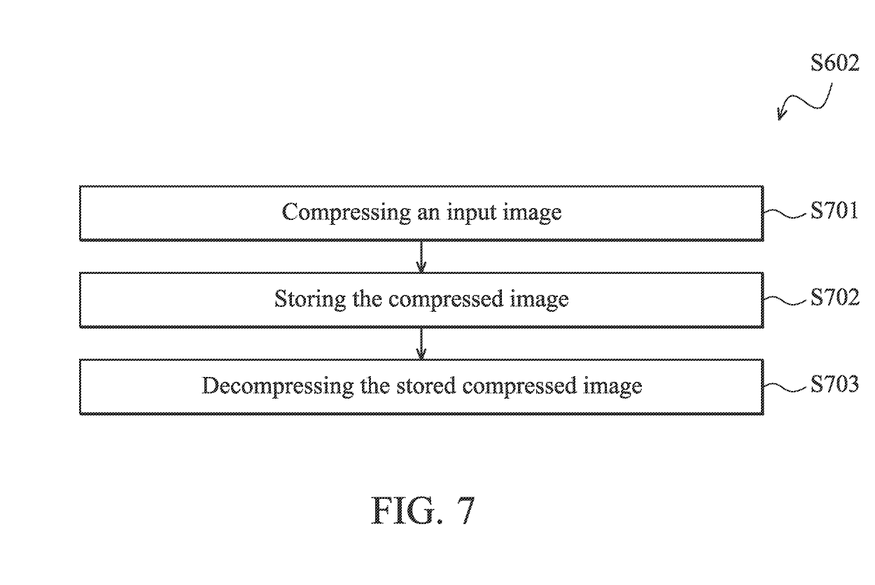

FIG. 7 is a schematic diagram of an exemplary embodiment of step S602. In step S701, an input image is compressed to generate a compressed image. The compressed image is stored (step S702). In step S703, the stored compressed image is decompressed. The decompressed result is served as a read-out image or a processing image.

For example, after receiving the first and the second input images, the first and the second input images are compressed to generate a first compressed image and a second compressed image. The first and the second compressed images are stored in a memory. Since the memory directly stores the compressed images, the usable space of the memory is increased and the bandwidth of the memory is reduced. When the memory is accessed, the stored compressed image is decompressed and the decompressed image is served as a processing image or a read-out image.

Refer to FIG. 6, step S603 is to transform the processing image to generate a first transformed image. In this embodiment, after transformation of the processing image, the resolution of the first transformed image is larger than the resolution of the processing image. In one embodiment, the resolution of the first transformed image is four times the resolution of the processing image.

The read-out image is transformed to generate a second transformed image (step S604). In this embodiment, the resolution of the second transformed image is larger than the resolution of the read-out image. In one embodiment, the resolutions of the first and the second transformed images are the same. Additionally, the resolution of the read-out image is the same as the resolution of the processing image.

The first and the second transformed images are processed to generate an output image (step S605) and the output image is provided to the display device to display an image (step S606). The invention does not limit how the first and the second transformed images are processed. In one embodiment, step S605 is to execute an OD process, but the disclosure is not limited thereto. In other embodiments, the first and the second transformed images are processed to generate information to be displayed in the display device according to other image processes.

In this embodiment, the resolutions of the processing image and the read-out image generated by step S602 are less than the resolution of the display device. For example, the resolutions of the processing image and the read-out image may be 1920×1080 and the resolution of the display device may be 3840×2160. In another embodiment, the resolution of the first transformed image generated by step S603 and the resolution of the second transformed image generated by step S604 are equal to the resolution of the display device.

In one embodiment, step S602 is to store the first and the second input images in a DRAM. Thus, data stored in the DRAM is directly served as a processing image or a read-out image. In another embodiment, step S602 is to compress the first and the second input images and then store the compressed images into the DRAM. In this case, data stored in the DRAM is first decompressed and then the decompressed result is served as the processing image or the read-out image.

In other embodiments, since the read-out image transformed by step S604 is present image information, when the read-out image is transformed, a transformed image segment of the read-out image is compressed and the compressed result replaces a portion of the read-out image stored in the DRAM. The stored compressed result can be served as previous image information. Since the DRAM is not required to store a transformed image, the bandwidth of the DRAM can be reduced, wherein the transformed image is not be compressed.

Before compressing, a reference condition is utilized to adjust an image data segment of a transformed image and the adjusted result is compressed. In one embodiment, the image data segment of the transformed image and the reference condition are processed by an OD process. In another embodiment, the reference condition is previous image information.

Since the data stored in the memory is replaced by the compressed image, the bandwidth of the memory can be reduced. Additionally, if the memory stores an un-compressed image, since the resolution of the un-compressed image is less than the resolution of the display device, the memory still has a large usable space.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a display panel displaying an image according to an output image; and
a timing controller comprising:
a receiving unit generating a processing image and a read-out image according to a first input image and a second input image;
a first transformation unit transforming the processing image to generate a first transformed image;
a second transformation unit transforming the read-out image to generate a second transformed image; and
a processing unit processing the first and the second transformed images to generate the output image, wherein a resolution of the processing image and a resolution of the read-out image are less than a resolution of the display panel.

2. The display device as claimed in claim 1, wherein a resolution of the first transformed image is larger than the resolution of the processing image.

3. The display device as claimed in claim 1, wherein a resolution of the second transformed image is larger than the resolution of the read-out image.

4. The display device as claimed in claim 1, wherein a resolution of the first transformed image is equal to the resolution of the display panel.

5. The display device as claimed in claim 1, wherein the processing unit processes the first and the second transformed images according to an over-driving process.

6. The display device as claimed in claim 1, wherein the receiving unit comprises:
a compression module compressing the read-out image to generate a compressed image;
a storage module storing the compressed image; and
a decompression module decompressing the compressed image stored in the storage module to generate the processing image.

7. The display device as claimed in claim 1, wherein the receiving unit comprises:
an adjustment module adjusting the read-out image to generate an adjusted image according to a reference condition;
a first compression module compressing the adjusted image to generate a first compressed image;
a storage module storing the first compressed image; and
a first decompression module decompressing the first compressed image stored in the storage module to generate the processing image.

8. The display device as claimed in claim 7, wherein the receiving unit further comprises
a second compression module compressing the first input image to generate a second compressed image, wherein the second compressed image is stored in the storage module; and
a second decompression module decompressing the second compressed image stored in the storage module to generate the read-out image.

9. The display device as claimed in claim 7, wherein the reference condition is the processing image.

10. The display device as claimed in claim 9, wherein the adjustment module adjusts the reference condition and the read-out image according to an over-driving process to generate the adjusted image.

11. A control method, comprising:
receiving a first input image and a second input image;
storing the first and the second input images and generating a processing image and a read-out image;
transforming the processing image to generate a first transformed image;
transforming the read-out image to generate a second transformed image;
processing the first and the second transformed images to generate an output image; and
providing the output image to a display device to display an image, wherein a resolution of the processing image and a resolution of the read-out image are less than a resolution of the display device.

12. The control method as claimed in claim 11, wherein a resolution of the first transformed image is larger than the resolution of the processing image.

13. The control method as claimed in claim 12, wherein the resolution of the first transformed image is four times the resolution of the processing image.

14. The control method as claimed in claim 12, wherein the resolution of the first transformed image is equal to the resolution of the display device.

15. The control method as claimed in claim 11, wherein the step of processing the first and the second transformed images to generate the output image is to execute an over-driving process for the first and the second transformed images.

16. The control method as claimed in claim 11, further comprising:
compressing the read-out image to generate a compressed image;
storing the compressed image to generate a stored compressed image; and
decompressing the stored compressed image to generate the processing image.

17. The control method as claimed in claim 11, further comprising:
adjusting the read-out image to generate an adjusted image according to a reference condition;
compressing the adjusted image to generate a first compressed image;
storing the first compressed image to generate a first stored compressed image; and
decompressing the first stored compressed image to generate the processing image.

18. The control method as claimed in claim 17, further comprising:
compressing the first input image to generate a second compressed image;
storing the second compressed image to generate a second stored compressed image; and
decompressing the second stored compressed image to generate the read-out image.

19. The control method as claimed in claim 17, wherein the reference condition is the processing image.

20. The control method as claimed in claim 19, wherein the step of adjusting the read-out image to generate the adjusted image according to the reference condition is to execute an over-driving process for the reference condition and the read-out image.
